(19) United States
(12) Patent Application Publication
(10) Pub. No.: US 2026/0064955 A1
(43) Pub. Date: Mar. 5, 2026

(54) TEXT GENERATION

(71) Applicant: QATENT SAS, Paris (FR)

(72) Inventors: François VELTZ, Paris (FR); Kim GERDES, Les Lilas (FR)

(73) Assignee: QATENT SAS, Paris (FR)

(21) Appl. No.: 19/110,698

(22) PCT Filed: Sep. 21, 2023
(86) PCT No.: PCT/EP2023/076120

§ 371 Date: Mar. 11, 2025

(30) Foreign Application Priority Data
Sep. 22, 2022 (GB) 2213823.4

(51) Int. Cl. G06F 40/186; G06F 3/04817; G06F 3/04842; G06F 40/242; G06N 3/0475

(52) U.S. Cl. CPC G06F 40/186; G06F 3/04817; G06F 3/04842; G06F 40/242; G06N 3/0475

(57) ABSTRACT

There is disclosed methods and systems for generating text comprising: receiving text input; determining generated text by using a transformer-based generation as an input and/or as an output of one or more rules applied on said transformer-based generation. Described developments relate to aspects comprising implemented logics for rules, composition of rules, transformers and/or adversarial generation networks, types of transformers (finite-memory, infinite-memory), management of words' suggestions and user inputs, management or prior documents, generation by attraction or by repulsion, simplification, generalization, specification, summarization, paraphrasing, heatmaps for essential features, predictions and management of advantages and/or technical effects, management of templates, and collaborative authoring. Various user interfaces are also described.

### FIELD OF INVENTION

There are described examples of generating texts, in different domains: patents, scientific articles, news, emails, short messages and other types of publications or communications.

### BACKGROUND

Play with words. The name of the game is the claim. Despite these statements, patent professionals (e.g., agents, attorneys, lawyers, litigators, examiners, professors and students) and computer linguistics experts (e.g., scientists in Natural Language Processing, computational linguistics professors, semantic web experts) rarely work together.

Both fields require advanced skills. Patent applications are generally drafted by patent agents or attorneys. Computers play little role beyond word processing software and machine translation. Patent experts generally do not show immoderate interest for computer linguistics. Symmetrically, current approaches in Natural Language Processing rarely discuss patent claims. For example, available parsers and taggers are not adapted to the structures of patent claim sentences which constitute an idiosyncratic language. Few vocabulary sources like dictionaries or ontologies are specifically designed for patents.

There is a need for methods and systems to generate texts, in particular scientific or patent texts.

### SUMMARY

There is disclosed methods and systems for generating text comprising: receiving text input; determining generated text by using a transformer-based generation as an input and/or as an output of one or more rules applied on said transformer-based generation. Described developments relate to aspects comprising implemented logics for rules, composition of rules, transformers and/or adversarial generation networks, types of transformers (finite-memory, infinite-memory), management of words'suggestions and user inputs, management or prior documents, generation by attraction or by repulsion, simplification, generalization, specification, summarization, paraphrasing, heatmaps for essential features, predictions and management of advantages and/or technical effects, management of templates, and collaborative authoring. Various user interfaces are also described.

### BRIEF DESCRIPTION OF DRAWINGS

FIG. 1 illustrates how text generation can occur in patents;

FIG. 2 shows an example of a workflow for text generation;

FIG. 3 illustrates examples of composition (regulation e.g., retroaction loops) of rule-based text generation and/or transformer-based text generation;

FIG. 4 illustrates examples of machine learning for quality content generation;

FIG. 5 illustrates examples of user interfaces for manipulating patent texts;

FIG. 6 illustrates an interface for toggling a text;

FIG. 7 illustrates claim morphing for text generation;

FIG. 8 illustrates drawing-to-text and text-to-drawing.

### DETAILED DESCRIPTION

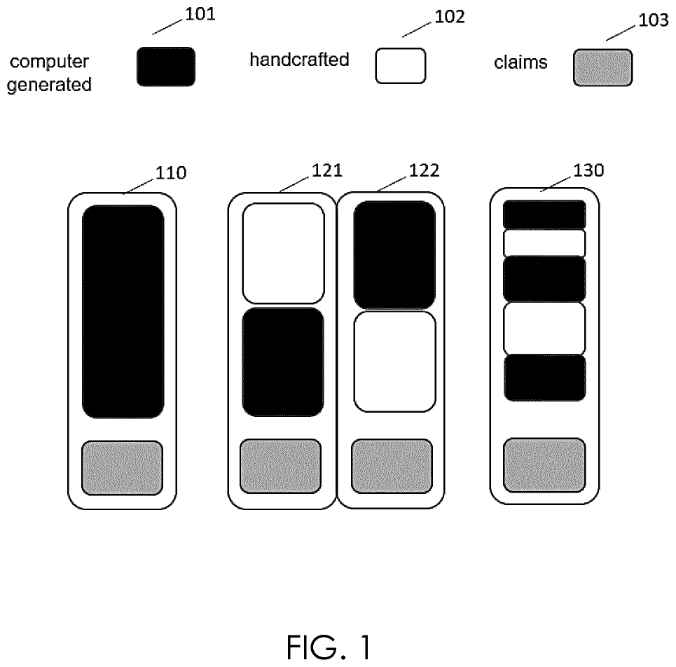

FIG. 1 illustrates text generation in patent documents.

Humans and machines are complementary. Machines do not forget, are never tired or overlooking things. Humans have intuition and know-how. Advantageously, by combining human work and machine work, “augmented patents” can be obtained. Advantages comprise better formal quality, better scope of protection, reuse of assets, etc.

As shown in example 110, the description can be entirely machine-generated (computer-generated or CG), based on the patent claims. Associated advantages comprise speed of generation, and thus possibly a high number of generations.

In an example 121, the computer-generated content can complete a first part which has been handcrafted. For example, the computer can fill-in the description up the 35 pages without additional page fee, and applicants can get additional fallbacks during prosecution.

In an example 122, the opposite operation is performed: computer-generated text comes first and the human drafter completes the machine-generated work. It can be noted that the order is generally not commutative: text A followed by text B does not mean the same than text B followed than text A. For example, if text A consists of terms'definitions and text B describes relations between terms, it is not equivalent to commute texts.

In an example 130, the “augmented” patent is composed of parts being handcrafted and parts being computer-generated. In some cases, the contents can be tightly intricated. Transformer based texts are often not very consistent, e.g., contradictions can occur. In general, the shorter the text the better the insertion of computer-generated text. Such a scheme is advantageous for patent documents.

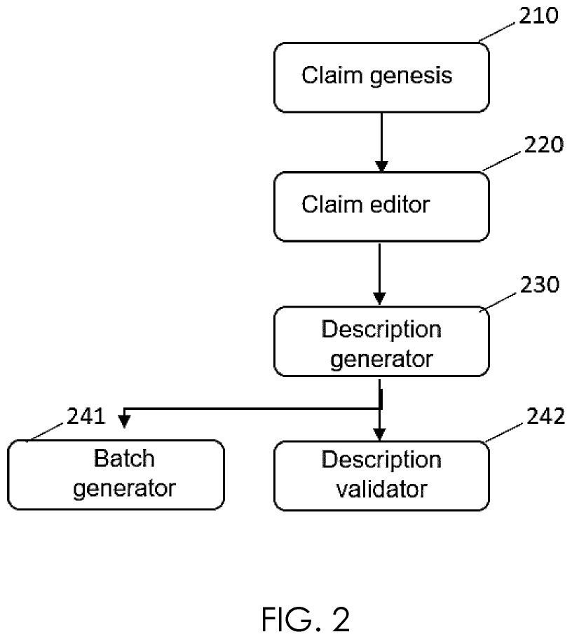

FIG. 2 shows a general workflow of text generation.

In an embodiment, a “claim genesis” module provides a plurality of methods to help casting patent claims. Methods can comprise determining via a graphical user interface one or more relationships between objects or features, starting or not from invention disclosure.

A module for claims'genesis 210 can define several tables.

One or more tables can define relationships between claims'features themselves, or between claims and invention disclosure (the initial invention document provided by an inventor to a patent attorney) For example, in the claim “1. A system comprising A, B and C”, different symbols can be used:
= can designate the strict identity relation (e.g., synonym), for example “a computer=a calculator”
≡ or ˜can designate an equivalence (e.g., near synonym), for example “a computer ˜a processing unit”, not in the meaning of patent novelty destruction
⇒ or → (the “implies” sign) can mean “logically implies that”. (e.g., “if A, then B” is equivalent to saying “A⇒B”). Many other verbs can be designated (“controls”, “acts on”)
<- can designate the inverse relation such as “is controlled by” (passive form)
↔ can designate a relationship of interaction (actions in both ways, even asymmetric)
⊂ (the “is included” in sign) can designate a relation of meronymy, for example “A⊂B” can mean “A is included in B”
⊃ (the “includes” sign) can designate a relation of meronymy, for example “A⊃B” can mean “A comprises B”
↑ (the “is a hyponym of” sign) can designate a relation of hyponymy, for example “A↑B” can mean “A is a hyponym of B”
␣ (the “is a hypernym of” sign) can designate a relation of hypernymy, for example “A␣B” can mean “A is a hypernym of B”

In an embodiment, verbs can be associated with such symbols, which can be advantageous for drawing-to-text and text-to-drawing.

A Claim Editor module 220 can be associated with one or more tools, for example providing analytics tools to improve your claim set (trends in patent classes, alternative vocabulary as determined by Wordnet or Wikipedia, definitions, etc)

A Description Generator module 230 can derive an entire patent application from handcrafted claims, by stacking variants of claims or combinations thereof.

A description generator module 230 can be associated with generation options, for example a selection of transformations performed on one or more claims (dependent and/or independent ones), or parts thereof. Transformations can comprise vocabulary operations (substitution of a word by another one, for example “while” is replaced by “until”; addition of one or more words; more complex transformations, for example rule-based e.g., if presence of “element” then add expression “in a blockchain”, etc) and/or other linguistic manipulations performed on claims or parts thereof. Predefined boiler plates can be used, for example triggered by the presence or absence of one or more words in claims. Said boiler plates can be static (invariants) or dynamically adjusted to establish a relation of description content and claims. In particular, personalized boiler plates can be handled (e.g., user preferences), also “corporate” ones (e.g., recurrent and/or past inventions can be summarized and reintroduced in combination, even considering 12 months and 18 months period for entry into the state-of-the art).

A description validator module 242 can allow the user—and/or automated proofreader—to review the generated description associated with claims. For example, the user can post-edit the generated specification. After post-edition of the generated draft, or considering an alien draft, tools can verify formal quality aspects of the draft (e.g., no mention of “the invention”, no cross-references for EP drafts, etc). Linguistic metrics and other criteria can be used. Substance also can be verified to some extent (e.g., continuous search in the prior art, guiding the generation or verifying rules and conditions). Various visualization tools can be used (e.g., highlighting of unclaimed matter if any, by comparing claims and description, etc). Fast deletion options can be used after generation (e.g., facet search generating an index of words being used, and counting the number of occurrences in the description). The validator can be made so as to speed-up reviewing process (e.g., peer review, collaborative authoring etc).

Advantageously, embodiments of the invention can allow a generation of the description which can comprise no (or less) errors, no (or less oversights), and in particular can comprise at least suggestions of adjacent technical developments (for example if an OLED screen is mentioned, then QLED or QD-OLED screens can be proposed).

An optional batch generator module 241 can manipulate the number and/or types of generation. Advantageously, since contents are machine-generated contents, it becomes inherently possible to generate a very high number of texts. Patent application generation assisted by machines can allow operations that no law firm, even large, can ever accomplish. In this perspective, text generation strongly impacts IP strategies. For example, a SEP (Standard Essential Patent) can be attacked (multiple adjacent publications) or defended (e.g., to prevent submarine patents or adverse party's rights weakening IP positions. Entire portfolios also can be treated.

### Coexistence of Initial Invention Disclosure and Patent Text (Not Shown)

Patent attorneys often feel or are “legally bonded” to incorporate the initial invention disclosure (noted ID), in order not to miss any possibly overlooked aspects of the invention. Incorporating the ID is thus on the safe side of drafting practices. Then what matters is to link the verbatim recopy of the ID with the interpretation work done by the patent attorney (claims'wording).

In an embodiment, “support sections” i.e., textual paragraphs can be generated to establish such links, describing the relationship between wording of the invention disclosure and the claims'wording. Such relationships can be given by the user of patent drafter, but many of them can be precomputed.

In some cases, for example when dealing with preprint articles, it also can be that verbatim recopy appears to be strictly required. In such cases, the described techniques enable the “coexistence” of initial ID and patent work, i.e., manages the linking between the two types of contents.

If and when possible, for example if the client agrees that the work done by the patent attorney restitutes 100% of the initial ID, then the patent attorney can skip verbatim recopy.

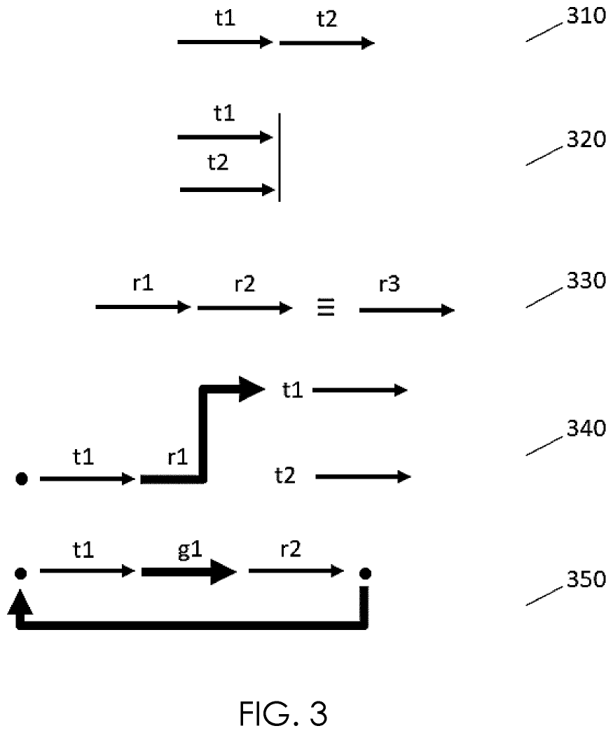

In this case, without verbatim recopy of the initial ID, it is advantageous to stack developments performed on these claims, thereby obtaining a patent application document. A patent description is indeed little more than stacking variants of the patent claims. Yet numerous contents that go “beyond human average” can be added. It is possible to suggest alternative terminologies, spreading the scope of the application, to add technical adjacent developments (e.g., blockchain embodiments, by having predefined paragraphs being combined with claims in project), to handle so called boiler-plates that generalize the invention, etc. As a result, the document can be systematically enriched (“augmented patent”). This proves to be useful for prosecution, when patent attorneys and examiners “shape” claims based on written support. FIG. 3 illustrates examples of regulation or retroaction loops between rule-based text generation and/or transformer-based text generation.

### Compositions

Transformers and their variants (more generally “language models”), noted (t), GANs and variants (e.g., CGANs), noted (g) and/or rules noted (r), can be composed (or combined, or intertwined, or assembled) in different ways (e.g., from automation or system control perspectives).

The composition can use arrangements in serial, and/or in parallel, and/or with one or more retroaction feedback loops, feedforward mechanism, etc.

Various schemes of control can be implemented and used: open-loop control, closed-loop control, feedback control systems, logic control, on-off control, linear control, non-linear control, proportional control, etc. Negative feedback (or balancing feedback) can be used. Feedforward can be used (e.g., use a measurement of a disturbance input to control a manipulated input).

System control or control techniques can be adaptive control, hierarchical, optimal, predictive, robust, linear, nonlinear, decentralized, distributed, deterministic, stochastic, stochastic, self-organized etc. Control can use artificial neural networks, Bayesian probability, fuzzy logic, machine learning, evolutionary computation, genetic algorithms or a combination of these methods, such as neuro-fuzzy algorithms.

Composition schemes can further comprise different mechanisms: retroaction, corrective feedback, feed-forward feedback, low-key feedback, recursion, iteration, attractor, cyclic feedback, etc.

### Rules

A rule designates various mechanisms (e.g., scripts, routines, equations, relations, etc). A rule can be a function (analytical function) and/or an algorithm (requiring time and execution to express results).

A rule can add and/or subtract (and/or replace) one or more words in a text.

A rule can comprise one or more of rules of inference. Rules of inference can comprise modus ponens, biconditional introduction or elimination, conjunction, disjunction, hypothetical syllogism, constructive or destructive dilemma, absorption or modus tollens or modus ponendo tollens, negation etc. A rule of inference, inference rule or transformation rule is a logical form consisting of a function which takes premises, analyzes their syntax, and returns a conclusion (or conclusions)

A rule can use different types of logic (paraconsistent logic, predicate logic, propositional calculus, substructural logic etc). Various systems of formal logic can be used (e.g. alternative semantics, attributional calculus, categorical logic, dependence logic, dynamic semantics, epsilon calculus, first-order logic, Frege's propositional calculus, fuzzy logic, higher-order logic, implicational propositional calculus, independence-friendly logic, infinitary logic, inquisitive semantics, intermediate logic, intuitionistic logic, many-sorted logic, Ω-logic, ordinal logic, paraconsistent logic, predicate calculus, propositional calculus, propositional proof system, quantum logic, second-order logic, two-variable logic, zeroth-order logic, etc)

Rules of replacement can be used (with properties such as associativity, commutativity, distributivity, double negation, transposition, etc.)

A rule can comprise one or more logic rules, as an articulated set of logical operators and objects. For example, a rule can be “B after A”. A rule (or part of a rule or premise or proposition) can apply to one or more objects. In one embodiment, a logic operator is a logic operator according to binary logic, fuzzy logic, probabilistic logic, intuitionistic logic, combinatorial logic, modal logic, propositional logic, polyvalent or multivalent logic, partial logic, or para-consistent logic (one or more logics can be implemented).

A rule can encode a business practice (e.g., list of sensors/actuators in a given industry) and/or a patent drafting practice (e.g., absence of the term “Claim” in the body of the description, introduction by the expression “in an embodiment”, etc).

### Transformers

Text Transformers (t) can be diverse. Pretrained Transformer models such as BERT, XLNet, and ROBERTa. Transformer-based models scale quadratically with the input sequence length and linearly with the number of classes. Transformers can be sequence-to-sequence.

The use of transformers can be diverse: they can perform tasks including machine translation, words'predictions, question answering, natural language inference, sentiment analysis, and document ranking for example. The architecture of transformers has been described in architecture published in a research paper titled “Attention Is All You Need”. Attention can be multi-head attention.

Transformers or “Language models” used for text generation according to the invention can comprise one or more of BERT (Pre-training of Deep Bidirectional Transformers for Language Understanding), GPT2 (Language Models Are Unsupervised Multitask Learners), XLNet (Generalized Autoregressive Pretraining for Language Understanding), ROBERTa (A Robustly Optimized BERT Pretraining Approach), ALBERT (A Lite BERT for Self-supervised Learning of Language Representations), T5 (exploring the Limits of Transfer Learning with a Unified Text-to-Text Transformer), GPT3 (Language Models Are Few-Shot Learners), ELECTRA (Pre-training Text Encoders as Discriminators Rather Than Generators), DeBERTa (Decoding-enhanced BERT with Disentangled Attention), or PaLM (Scaling Language Modeling with Pathways). Transformers can have a finite memory capacity (they are forced to drop old information). Transformers also can be infinite memory transformers (can handle arbitrarily long contexts i.e., unbounded long-term memory).

In an embodiment, a transformer is an upstream-context transformer, wherein an upstream transformer takes text situated before the placement of generated text to compute a generated text.

In an embodiment, a transformer is a transformer is a downstream-context transformer wherein a downstream transformer takes text situated after the placement of generated text to compute a generated text.

### Generative Adversarial Networks

In substitution or in combination to transformers (t), one or more generative adversarial networks (GAN) can be used.

A generative adversarial network (GAN) is a class of machine learning frameworks. Two neural networks contest with each other in a game in the form of a zero-sum game, where one agent's gain is another agent's loss. Variants of GANs include one or more of: a Conditional GAN, GANS with alternative architectures, GANs with alternative objectives, Wasserstein GAN (WGAN), GANs with more than 2 players (e.g., InfoGAN, Bidirectional GAN or BiGAN, Variational autoencoder GAN or VAEGAN, Adversarial autoencoder or CycleGAN), GANs with particularly large or small scales (e.g., BigGAN, Invertible data augmentation, SinGAN, StyleGAN series, Progressive GAN, StyleGAN-1, StyleGAN-2 or StyleGAN-3) In some embodiments, one or more conditional GANs (CGANs) can be used (or composed with one or more GANs and/or transformers). CGANs are an extension of the GANs model. CGANs are allowed to generate texts that have certain conditions or attributes.

More generally, different types of networks can be implemented: FC (fully connected network), CNN (convolutional neural network), RNN ((simple) recurrent neural network), LSTM (long short-term memory network), GRU (gated recurrent unit network), SEQ2SEQ (sequence-to-sequence network), GAN (generative adversarial network), AE (autoencoder network), and/or TRANS (transformer-based network)

The FIG. 3 shows some examples of compositions of rules (r), transformers (t) and/or GANs (g) Transformers can be chained or arranged in serial 310: t2 can be applied to the result of t1. Transformers can be arranged in parallel 320; t1 and t2 are performed in parallel (and further composed or merged by one or more rules, not shown). In a similar way, rules (r) and/or GANs and/or transformers (t) can be chained. For example, several rules can be applied in sequence (r1 then r2, equivalent to a r3). Components can be mixed (not shown); for example, a text generated by a transformer t1 can be filtered or rearranged by a rule r1 (for example verifying the presence or absence of certain predefined term), then be handled by a transformer t2.

More sophisticated schemes can be performed; for example, at 340, the output of a first transformer t1 can be filtered or augmented by a rule r1, which can direct the output to a transformer t1 instead of a transformer t2 based on the satisfaction of predefined conditions.

Feedbacks and variants can be applied to the compositions of rules (r), transformers (t) and/or GANs (g). For example, at 350, a transformer t1 can be chained with a GAN g1, and the associated text output can be transformed according to a rule r2.

Composition can occur between different inputs and outputs. Composition also can occur between internal control points: for example, at 350, a transformer t1 can be chained with one or more control points of a GAN g1, and the associated text output can be transformed according to a rule r2. Compared to the previous example, t1 acts on internal components of the GAN g1, as opposed to the input of g1. Thus, both inputs, outputs or control points of t, r and/or g. Such control points can be predefined or accessible; in some cases (black boxes), control points can be forced (by accessing hyperparameters of models, code analysis breaks, etc).

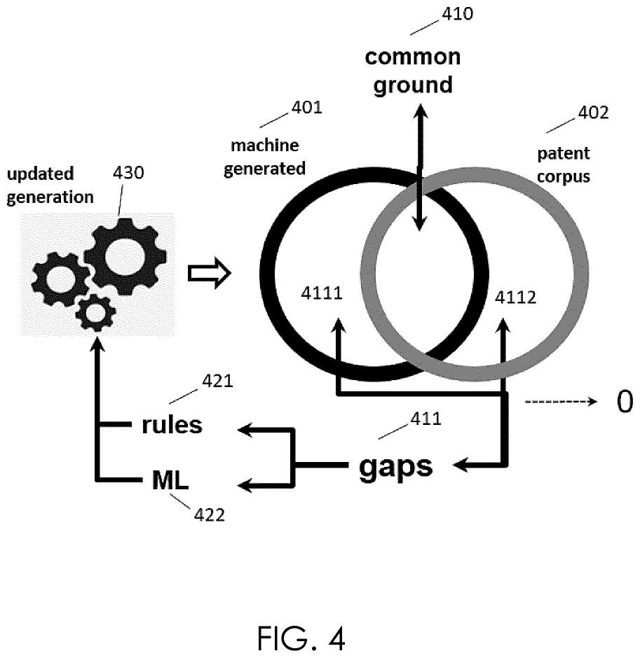

FIG. 4 illustrates examples of machine learning for quality content generation.

FIG. 4 shows an example of a (virtuous) quality circle. Calling “natural patents” 402 the texts having been filed by man, and “CG” for “computer-generated” or “computer-assisted” patents 401 (also named “artificial”patents), there are three different situations.

Some texts 4111 may be generated by machines but may have no real natural counterparts. This includes (mostly semantic) errors but not only; so-called “hallucinations” or other alien texts may be produced, with value of inventive step attacks (e.g., incentives to combine, bridges between corpora, etc). Some texts can be at least comparable (common ground 410). This includes description of drawings, which are described in a systematical way by patent attorneys. Some texts 4112 may not (at least theoretically) be obtained by algorithms (yet, it is conceivable that any text can be generated).

By individual comparison, it is possible to allocate parts of the description to each of these categories. This can lead to the determination of new generation rules 421. Once the coverage progresses (the quantity of texts 401 and 402 diminishes, while part 410 increases), massive comparisons can be handled, and in particular machine learning 422 can be deployed, helping decreasing the gaps 411. As claimed trees are parts of patents (made for dissemination by design and thus widely exempted from copyright), it is indeed possible to reuse existing natural (or handcrafted) claim trees, compare the obtained corpus with the natural ones and converge in generation or adjust it (updated generation 430). The study of these ensembles can reveal creativity and/or invention insights.

In particular, the analysis conducted on these ensembles can lead to “augmented patents”, i.e., patents which are beyond human average, and even well beyond (computers can infer combinations which are overlooked by humans, transpose inventions systematically, beyond the silo thinking which is necessarily in place with static-or even dynamic-patent classification mechanisms).

In other words, some of the identified gaps 411 can be automatically compensated, while some other require human scrutiny and the elaboration of one or more generation rules or systems of rules or combination of rules and/or transformers.

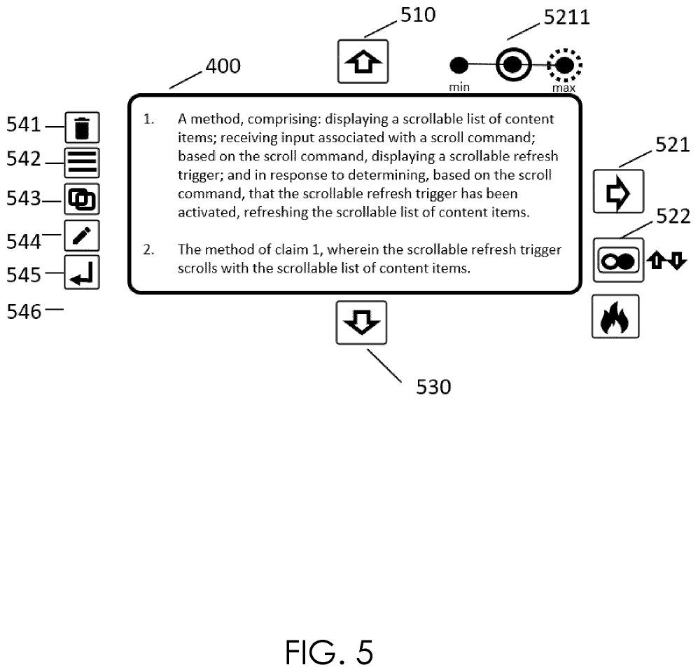

FIG. 5 illustrates examples of user interfaces for manipulating patent texts.

FIG. 5 shows examples of features of a graphical user interface. A text or part or text 400 is associated with different actions (when one of the shown icons is selected, the text 400 is transformed)

A button “up” 510 can trigger a text transformation wherein the text 400 is replaced by a text 501 (not shown). The text 501 can be obtained by replacing one or more words of the text 400 by their hypernyms. The text can be thus more generic.

A button “down” 530 can trigger a text transformation wherein the text 400 is replaced by a text 502 (not shown). The text 502 can be obtained by replacing one or more words of the text 400 by their hyponyms. The text can be thus more specific.

A button “equivalent” 521 can trigger a text transformation wherein the text 400 is replaced by a text 403 (not shown). The text 403 can be obtained by replacing one or more words of the text 400 by their synonyms. The text can be thus rephrased or rewritten.

Meronyms also can be used (not shown).

A button “toggle” 522 can invite the user to highlight one or more words (“essential features”), thereby teaching or improving downstream machine algorithms.

On the left of the figure stand general options: action 541 can place text or part of text to trash (forget); action 542 can provide a grip for drag and drop (e.g., reordering of contents); action 543 can duplicate the text in another DIV or DOM node placed below for further editing; action 544 can enable editing mode of the text 400; action 545 can allow creating a fork of the initial text when sufficiently edited (a copy of the text being edited can be placed below or adjacent the current text 400.) On the right of the figure (or elsewhere) can stand further text transformations. Action 521 can replace the current text 400 by a text 404 (not shown), wherein one or more words are replaced by their synonyms and/or their definitions. The user can click again and another version of the text can be further determined and displayed. Action 522 when triggered on first click can display the text being analyzed wherein one or more words are provided with alternatives, which can be toggled on or off by the user. When the user is satisfied, a click on 545 or a second click on 522 can copy a generated text below the current text 400, wherein the generated text lists selected alternatives hardcoded in the initial text 400.

In some further optional embodiments, a text transformation can be rendered parametric. For example, the paraphrasing function 521 (or the generalization function 510, or the specification function 530) can be parametrized by the selection of one threshold amongst several. For example, a selectable and movable cursor 5211 can get 3 different positions (e.g., extreme left minimal changes, normal centered, extreme right for maximal changes) which can be used as a modifier or modulator of the paraphrasing function. A slider also can help ranking different paraphrasing methods. Generally speaking, the diversity of paraphrasing systems can be advantageous for the user and/or the scope of protection.

The placement of the different icons for actions can be placed in many different ways. It is advantageous to have generalization 410 (higher level of abstraction) placed on top of the text, paraphrasing 421 at the right or left (same level) of abstraction, specification 430 (lower level of abstraction) placed below the text. Paraphrasing even can be directional (direction to the left or to the right can trigger different kinds of paraphrasing). Also, corners (not shown) can be used.

Other actions can be envisioned. For example, in one or more selected parts of the text (whole text or some specific sections), the term “is” can be replaced by the expression “can be” which emphasizes a possibility or opportunity. The term “and” or “or” can be replaced by “and/or” (A and/or B means three possibilities: A, B and “A and B”. The term “we” (as often found in scientific articles) can be removed and turned into impersonal active/passive sentences. A “reduction” can be triggered: one or more long sentences can be expensive to translate (or otherwise complex for machine translation); then a mechanism can split long sentences into a plurality of shorter ones. Such mechanisms can be seen as “image processing” options, wherein linguistics is manipulated at the speed of computers, avoiding repetitive work or otherwise painful manual review and adjustments.

### General User Interfaces Examples

An interface can be provided with selectable icons to apply one or more text transformations:
“generalize”: mostly by the use of hypernyms;
“specify”: mostly by the use of hyponyms;
“paraphrase”or “rewrite:”mostly by the use of synonyms;
“simplify”: mostly by forcing replacement of words by their plain English counterparts;
“sophisticate”: mostly by using less frequent words;
“intermediate generalizations”: as used in patent documents, these designate the combinations of hypernyms and/or hyponyms (and/or synonyms, antonyms, meronyms, etc);
“technical”: a list of common words can be associated as non-technical or with bad patent flavor e.g., “email” can be replaced by more acceptable “message”; proceeding so a “business method” can be transcoded into a “software patent”. More generally, a given text can be slightly changed to optimize chances of routing the case to specific examining divisions (so-called “art unit prediction”)
“shorter”: the syntax of the initial text is manipulated to remove unnecessary clauses or technical embeddings (a “server” can replace the expression “computer in a network”)
“longer”: opposite of the preceding, wherein a term is replaced by its equivalent definition (a “server” is replaced by a “computer in a network”)

Some of the operations can be mutually exclusive (e.g., generalize and specify) but most of them can coexist to some extent (e.g., intermediate generalizations) Dealing with technical contents, patent documents generally use emotionless terms and expressions. When applied to mainstream contents, for example blog posts, emails, short messages e.g., tweets, other types of transformations can be determined:
“more formal”: an email with words considered familiar can be replaced by more formal expressions and terms
“more familiar”: opposite of the preceding, mostly by the use of predefined terms or expressions belonging to the familiar contexts;
“funnier”: mostly by the use of predefined chunks or parts of sentences;
“more serious”: opposite of the preceding, wherein predefined terms and expressions are used;
“more explicit”: an initial text can avoid some black boxes by replacing said terms by a proper definition which tends to be self-sufficient; for example, the expression “machine learning mechanism”can be replace by “auto-supervised machine learning”;
“more implicit”: opposite of the preceding, wherein more vague statements can be needed in some contexts; in this case a well-defined term or expression can be replaced by a fuzzier statement; with the preceding example the expression “auto-supervised machine learning” can be replaced by “machine learning mechanism”
“more punchline”: terms and/or expressions can be replaced by predefined terms and/or expressions of a predefined library of “punchlines”expressions;

In an embodiment, the corresponding types or categories of lexicons can be learned by tagging, classification, annotation, handcrafted libraries, or a combination thereof. Such libraries can be used as “filters”to color or otherwise modify the initial text.

As in an image editing software, a plurality of transformation presets can be predefined, and successively used (for example, removal of “we” to be found in scientific articles, turn a passive voice form into an active voice, modifying a long sentence into a plurality of shorter ones thus decreasing complexity and cost of translation, etc).

In an embodiment, one or more text transformations can be cycled, in order to improve said transformations and find stable or convergent states. For example, a text which is successively rendered “more generic” then “more specific” then again “more generic” might be stable (the initial text is re-obtained), or can diverge.

In some embodiments, it is possible to comment or otherwise annotate patent text, to subscribe for possible modifications and receive notifications (“follow”), report an error or abuse, to bookmark an expression etc.

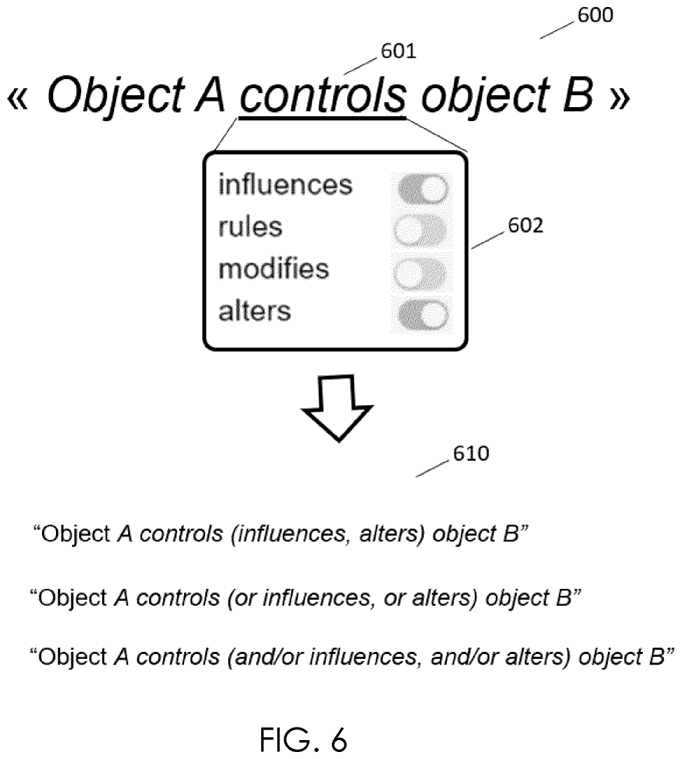

FIG. 6 illustrates an interface for toggling a text.

Drafters of patent documents are generally interested in being exhaustive and/or maximizing semantic coverage. One technical translation of such an objective can be obtained by proposing replacement words, for a plurality of words of the initial text, and validating one or more of these candidate replacements, in order to generate a composite text using parenthesis or equivalent expressions.

For example, considering the expression 600: “Object A controls Object B”, the user interface presented on the FIG. 6 can be proposed, wherein upon click on the verb “controls” 601 various replacement words 602 can be ranked then presented to the user, who can toggle on or off the different propositions (for the example “influences”, “rules”, “modifies”and “alters”.

Supposing now that the user toggles on “influences” and “alters”, the various corresponding texts 610 can be produced and inserted into the description of the patent application:
“Object A controls (or influences, or alters) Object B”
“Object A controls (and/or influences, and/or alters) Object B”
“Object A controls (or one more of the verbs comprising to influence and to alter) object B”

Other variants of these sentences can be produced (e.g., individualized sentences, in compact form or not).

In other words, multiple choices for variants are presented to the user visualizing a patent claim (or more generally a text or sentence), e.g., for patent drafting.

In an embodiment, the user selects if a given variant is to be used for text generation. If applicable (if selected), then texts are generated in a combinatorial way. For example, if the user sees “a mouse with a (touch, tactile, haptic) screen” (wherein “touch”, “tactile” and “haptic” are shown as suggested variants), the following sentences will be produced: “a mouse with a touch screen”, “a mouse with a tactile screen”, “a mouse with a haptic screen”. The latter forms make every “embodiment” go “individualized”; This presents advantages for patent laws. Alternatively, compact forms can be produced, the following sentence is produced “a mouse with a (touch, tactile, haptic) screen”; the visualization is written down in a compact form, which may be equivalent to the forms designated precedingly.

Such toggling operations performed on user interfaces can be used to create paraphrases (e.g., synonym sentences) or so-called “intermediate generalizations” (combination of hyponyms, hypernyms, synonyms), presenting different levels of abstractions (“a solar bicycle”, “an electrical tricycle”, “an electrical vehicle”)

The user interface can show replacement words ranked in certain ways (for example grouping and raking words from hyponyms, to synonyms or similar terms, until hyperonyms). For example, the term “pizza” can be varied into {“sandwich”, “hamburger”}, “dish”, “nutriment” and “food”.

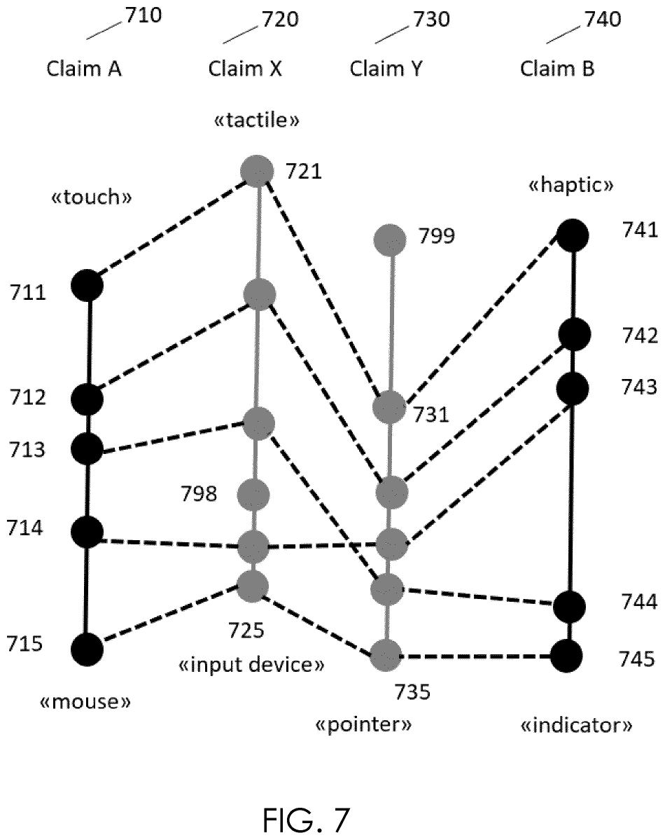

FIG. 7 illustrates claim morphing for text generation.

In an embodiment, “claim morphing” can be used.

Claim morphing allows to determine a desired discrete number of intermediates between two given claims (or more generally claim trees).

For example, in the man-machine interface, the user can indicate two given claims, claim A 710 and claim B 740, and request N intermediate states of claims

In the illustrated example, N=2: claim 720 and claim 730. Claim A comprises 5 words or groups of words (e.g., essential features, “touch-screen” 711, 712, 713, 714, 715) and Claim B also comprises 5 words or groups of words (“haptic screen” 741, 742, 743, 744, 745).

Different methods can be proposed to obtain such claim intermediaries.

Alignment or reordering of words can be performed. As one or more dictionary define chains of synonyms, hyperonyms, hyponyms and/or meronyms (e.g., “transportation system”-> “car” or “vehicle”-> tire->wheel->hub->lug->rim->spoke), it is possible to determine or follow one or more chains of words in claims. Paths of words can then be determined, for example path 711, 721, 731, 741 or path 715, 725, 735, 745) For example, the word 711 “touch-screen” in Claim A becomes “tactile-screen” 721 in the second claim and “haptic screen” 731 in the third claim which equals “haptic screen” 741 in final Claim B. Likewise, correspondences can be determined (possibly “forced”) between the different initial, intermediate and final claims. One or more intermediate sentences can thus be determined. Changing a few essential features locally can change the global meaning of a whole sentence, and thus obtaining claim morphing i.e., “intermediate claims”.

The ordering along paths (i.e., the intermediate claims) can be diverse: for example, words can be ordered thus distributed along a direction going from hyponymy to hypernymy, for the sake of parsimony (e.g., N equals 2), but combinatorics can be used as well (e.g., to create a cloud of sentences, such as 26 intermediate sentences).

In some cases, some words may have no counterparts (798 or 799), upstream of downstream (for example, if the number of considered words are not equal between claim A and B). A plurality of words (or groups of words) can be associated with one upstream single word (or group of words), and inversely, one single word (or group of words) can be associated with a downstream plurality of words (or groups of words). Cardinality can also be managed in other ways (not shown, using random, asking the user, etc).

Intermediate texts can be hardcoded in different ways. In some cases, the distribution of variants can be performed in a balanced way. Some words can be skipped, or some words can be associated to several paths. Skipped words or variants can be randomly chosen. The distribution can be diverse (equiprobability or specific distribution)). In an embodiment, the positional order of a word to be varied can matter, etc.

One use case of claim morphing relates to the management of patent portfolios. For example, having 3000 patent applications or granted patents for an essential standard (e.g., in 5G telecommunication technology), it is possible to define an arbitrary high number of intermediate claim trees, for example 30 000. Based on these 30 000 claim trees, 30 000 corresponding descriptions can be generated, and later electronically published (as Internet disclosures or via patent office's e.g., early publications) Such operations can significantly decrease the likelihood of future submarine or other adverse patents, avoiding the situation where portfolios lead to mutual dependency and thus annihilating competitive advantage if preexisting. These operations also can leverage the use of machines (such results may not be obtained by even large law firms).

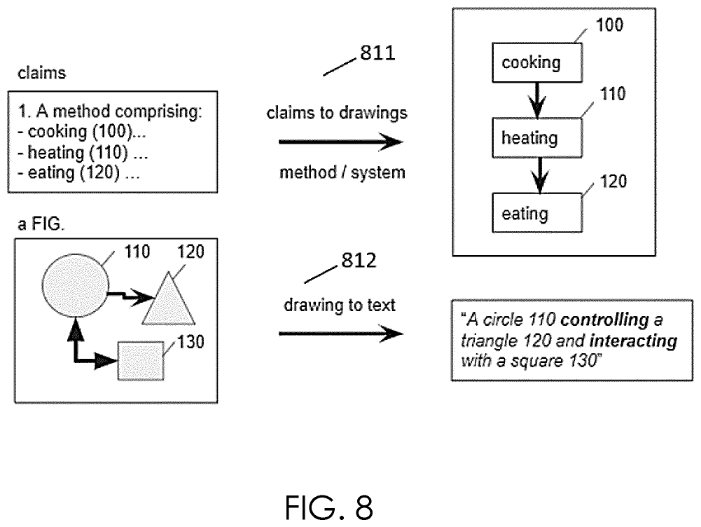

### Fig. 8 Illustrates Drawing-to-text and Text-to-drawing.

While Automatic Language Processing is progressing by leaps and bounds, an important part of the technical information contained in patents is encoded in a graphic way. This information remains difficult to access, but can be strategic.

As described for FIG. 2, one or more verbs can be annotated to reflect the relationships between words.

### For Example,

“to comprise” can be associated with inclusion ⊃
“to provide” can be associated with symbol →
“to receive” can be associated with symbol ←
“to connect” can be associated with symbol ↔
“to be arranged in” can be associated with inclusion ⊂

Inclusion can be reflected in drawings. When considering a sentence comprising “A comprises B” it is possible to show that B is located inside object A. The different unidirectional arrows also serve translating into drawings the various encountered relationships. “A controls B” translates into a unidirectional arrow from A to B (A→B). The other way around, “A receives B” translates into a unidirectional arrow in the opposite direction (A←B). An interaction “to associate” or “to merge” or “to couple” is translated into a ↔ symbol.

By annotating thousands of verbs, it is possible to translate text into drawings 811. Conflicts or indetermination can be prompted to the user for disambiguation. A raw first drawing, automatically generated, which drawing is preferably editable, can be at least proposed to the user. The user thus has a drawing to start with. Errors in relationships can be more easily detected in the form of visuals than in pure text form.

Aside verbs, there are a set of expressions found in patent claims that also can be associated with drawings, for example frequent expressions such as “releasable connection” (→ and ←), “associated with” (↔), “connected to” (↔), etc.

Conversely, by performing image recognition (e.g., detection of shapes and edges, arrows etc), it is possible to convert a given drawing into a raw (editable) text 812.

This analysis described above can come in addition to automatic image description (or generation).

For patent drafting purposes, a method claim can be converted into a workflow (i.e., setting up the elements to post-edit the design). A system claim can be converted into a block diagram (an editable first draft).

In addition to the above, there can be constituted a library of recurrent objects in the patent texts (“computer”, “CPU”, “user”, etc). A few thousands of objects, in categories, can be advantageous for the user to choose from. When said objects'drawings are free of IP rights, the combination of the techniques described above is advantageous for patent drafting. The library can be obtained by image extraction and mining techniques, possibly extracted if not merged in real-time (for example if an “intelligent toothbrush” is desired, candidates of images can be retrieved and further composed).

Various embodiments are now described.

### Paraphrasing Using Plain English

In an embodiment, a text transformation can consist in replacing words of the initial claim by plain English (this designate simple vocabulary). Lexical simplification for example can be obtained by LSBERT. For example, a given claim tree, or more generally a text, can be translated into “plain English”, e.g., by forcing word-by-word replacement.

Plain English (or layman's terms, or Simple English, or “Basic English”) is a language that is considered to be clear and concise. It is a simplified subset of regular English. Basic English includes a simple grammar for modifying or combining its 850 words to talk about additional meanings (morphological derivation or inflection). The grammar is based on English, but is much simpler. It usually avoids the use of uncommon vocabulary and lesser-known euphemisms to explain the subject. Plain English wording is intended to be suitable for a general audience; it allows for comprehensive understanding to help readers understand a topic.

Various data sources can be used, for example the technical lexicon of Simplified Technical English (STE) which is an international specification for the preparation of technical documentation in a controlled language.

### Anti-Search

In an optional embodiment, there is provided an “anti-search” feature. The generation mode is optional and can be activated by the user. This mode is “novelty-by-design”.

With finite dictionaries and defined patent corpus, it becomes possible to guide generation towards texts which present novelty features. In an embodiment, the claims as being typed are continuously searched and suggestions are determined, ranked and proposed to the user depending on (for example) a) what has been typed so far and b) what is present in the prior art database. In more details, the autocompletion lists different possibilities to be validated by the user. These suggestions are ranked to associate probability of presence in the prior art: the least probable parts of sentences are shown in priority.

One way of performing this objective is to manage finite lists of words (features). If the user types a b c and if abcd and abce are present in the corpus, the suggestion will propose abcf, because f is present in the dictionary {f, g, h, i . . . x, y, z} while feature f does not appear in prior art database. Beyond mere binary choice (presence or absence), the proximity or similarity between words of the (completion) dictionary can be predefined (possibly between several models of contexts can be determined). Existing proximity or similarity models can lead maximizing novelty (e.g., the most unlikely completion, knowing that very weird results cannot be proposed, as the finite or restricted dictionary comprises reasonable propositions by construction).

Words that are present in the dictionary and which are not present in prior art database (or not frequently) are proposed in priority. Ranking of absent or not frequent words, yet similar or acceptable terms from the technical perspective, can be sophisticated, e.g., according to a set of filters, for example locally acceptable (i.e., in the part of the sentence), while globally rare (i.e., claim considered as a whole)

Ranking can use color codes, for example present words are colored in red and absent or unlikely words are colored in green. The user can switch from search to anti-search mode in a click.

Advantageously, the user is guided by the machine, trying to find sweet spots in database (“white space”or “gaps”).

In an embodiment, the user can activate a drafting guide, with an anti-autocomplete mode which comprises continuous search and proposes words absent from the prior art corpus amongst predefined words (for example chosen amongst low frequencies of occurrences).

### Counter-Generation

In an embodiment, the generation can be guided i.e., by using a reference or pivot document.

In an embodiment, the generation can be as closed as possible to said document (e.g., reutilizing vocabulary used in said document, if not entire chunks or parts of text). This “attraction” is the case when generation is aimed at converting an article or invention disclosure into a patent document. Different models can be used to minimize the discrepancy.

To the opposite, the generation can be guided to depart from said reference document. This “repulsion” is for example the case when generation is aimed at avoiding a prior art document. In such a case, words in the generation should be as different as possible as words in the reference document. Different models can be used to maximize the discrepancy.

Above embodiments can be combined: for a certain part of the sentence, attraction can lead, while the other part of the sentence is generated according to repulsion (preamble, characterizing part). A sentence can be broken down into multiple parts (equal or more than three), each part being associated with a command or filter (“attraction”, “repulsion”). The choice can even be non-binary (levels of similarity to choose from).

### Non-Fungible Tokens

In an embodiment, a high number of published near-duplicate or similar patents (for example generated according to diverse selected similarity requirements) can be associated with one or more Non-Fungible Tokens. The legal rights associated with the initial considered patent can remain unchanged, but the beam of NFTs can prove adjacent rights, “extending” the standard patent (for example with the initial document linking to said NFTs)

### Use of Blockchains or Crypto-Ledgers

In an embodiment, the beam of similar generated patents can be managed in or by one or more blockchains, proving date of creation.

In an embodiment, one or more smart contracts are associated with one or more generated patents. The beam or set of generated patents can then be associated with a plurality of smart contracts.

A smart contract can in particular relate to the computer executable code associated with a patent document (an “augmented patent”) thus can be provided with executable source code or other services which go beyond mere textual description (e.g., source code, webservice, data sets or points, etc).

### Preprint Articles to Prototypes Claims

When a scientist is finalizing a scientific article, he/she often has to wait for a patent filing before being authorized to publish said article. In practice, this can take up to several months, the time needed to have a patent counsel to draft and file the patent application. This delay often is not welcome, because too long. Or it can block or freeze communication of said article. Machine generated patents can help reducing time-to-file.

In an embodiment, the pre-print article is used to generate prototype-claims. A scientific article generally has a standard structure, and stable one. This enables machine learning to extract features and cast them in prototype claims, which can be later used in the patent claim editor, and then used for description generation. As a result, the scientist author and/or inventor can get a patent filing with minimal delays.

### Machine Translation

Texts generated in English can be used for machine translation.

In an embodiment, the user getting a generated patent application in English also can be provided with the translation of said generated patent application in the 9 other patent languages aside English. The user can thus publish these contents on the Internet, blocking or at least preventing adverse parties'rights (to patent exact same or similar features, in territories which are not elected by the patent applicant).

Translations, made by man and/or machine, can be literal but often contain interpretations to some extent. When patent documents are translated on-the-fly, i.e., “on demand” (as it is today), the overall “extension” of the prior art domain is limited. But at least theoretically: all—if not: the vast majority—of existing texts could be translated at once in all (or many) available languages and this could significantly extend the amount of prior art.

### Coherence and Consistency

“Coherence” and “consistency” are two qualities that are often associated with good or clear writing. “Coherence” is the quality of being local and orderly. Dictionaries indicate that “coherence” designates a systematic or logical connection of written elements (synonyms: balance, concinnity, consonance, consonancy, harmony, orchestration, proportion, symmetry, symphony, unity). “Consistency” is the quality of being uniform (mostly by reusing terms or antecedences). In writing, coherence generally refers to the smooth and logical flow of writing and consistency refers to the uniformity of the style and content.

Natural Language Generation can handle coherence and/or consistency in various ways. For example, a master transformer can define the structure of the document while several other systems (transformers, GANs or the like) can determine the different sub-contents. Each sub section can be generated in a way that maintains said coherence and/or consistency, if said properties are somehow quantified (e.g., metrics, rules, etc).

As a consequence, and corollary, in some embodiments, internal contradictions of a generated text can be detected (post generation, alleviating or mitigating changes) and/or avoided (before generation, by internal adjustments of the generative models)

In an embodiment, a first neural network is trained to construct the structure of the patent document, including titles and subtitles or other substructures. Then a series of secondary neural networks trained for each specific section fills-in the texts under each title or subtitle. The titles and subtitles can also serve as prefixes (trigger words) for the generation, which eliminates the need for separate models for each sub-text.

### Low-Cost or Cost-Efficient Patents

Generating texts according to embodiments of the invention allow to significantly reduce time-to-file of patent applications.

A “good” patent is a document which is “well-written” but also which is filed early on (patents are part of a rat race against time). A genius idea if poorly claimed can lead to a “poor” patent (not granted) ; to the opposite an “average” idea claimed, described and filed very early can still lead to a grant. The “quality” of a patent is thus a compromise or trade-off between drafting quality and time of filing. An efficient document in terms of grant and/or scope of protection shall balance drafting quality (˜form) and early filing (˜substance).

As ideas are up in-the-air, or proceed by cycles of product development and R&D programs, it can be advantageous to file as early as possible. For example, recent developments in metaverse domains can benefit from early filings in late 2022, while literature related to crypto ledgers is now dense, and many if not all inventions relating to “touch screens” has been addressed for decades now.

### Terminology Trends

Analyzing the growth of the use of words, for example CPC class by CPC class, one can to detect the emergence of new words (“technical embedding”, in the meaning that a new term can embed one or more technologies and its implicit features).

In theory, patent claims shall contain terminology that is stable and widespread. For example, the term “blockchain” may have taken several years to enter the patent corpus because it was necessary that the underlying components of this notion were clarified. In the end, a patent attorney or agent can feel confident that the word is stable and then decides to use it, leading to a “dialog” with the examiner. The patent applicant can be its own lexicographer, in that an unknown word can be introduced in claims if the description clarifies said word with definitions (the latter are often reintroduced in claims as claims shall be self-explanatory).

Some tests indicate that new words first enter the description of patent applications without being part of the claims at first, then later are present in claims in divisional applications or during prosecution, and, in the end, appear in dependent claims, before entering the Claim 1 “circle” or “arena”. The paths of words can be studied and useful conclusions can be drawn for using a word or another one (e.g., for “amplification”in corpus).

Interesting correlations with scientific publications and also blogs or Internet contents can be performed. Patterns of evolutions in words'uses can indicate underlying technology trends, which can be of the highest interest for R&D departments and related ones (innovation programs, patenting activities, etc).

### Collaborative Authoring of Claims and Generations

Nowadays, the relationships between the inventor(s), inhouse and/or outside counsels, and applicant(s) presents many inefficiencies.

For example, the patent drafter often is legally-or at least morally-bounded by the initial invention disclosure elaborated by the inventor: this can lead to the reincorporation of written contents into the patent description, while it may have been better to start fresh from a blank page. Also, peer-review is not systematically implemented within law firms (while in practice this exercise is efficient and useful). A related docket can be drafted by another agent or attorney within the same law firm (or different law firms as IP providers): this presents the advantage of increased “entropy” (more or different written perspectives on a given topic) but this also lead to inconsistencies in portfolios. Computer generated texts allow to increase uniformity, at least coherence and/or consistency between texts. Texts can become more comparable (which is also two-folds, both an advantage and an inconvenient).

In some embodiments, part of the text generation is collaborative (ex: by using an Etherpad or wiki document with multiple authors if not inventors). New organizations of content production can thus lead to more sophisticated and valuable inventions.

### Gamification

As a complement to text generations methods and systems, question & answering methods and systems can challenge the invention(s) under drafting.

More generally, generation can be “gamified” in multiple ways (e.g., competition systems, ratings, annotations, milestones, votes, perks, modifiers, etc). Video games generally implement systems that can be transposed (i.e., determined and adapted) to patent drafting.

### Personalization(s) of Text Generation

The use of user preferences can be advantageous for generation.

Some users may indeed come with their own practices, habits and preferences (e.g., general templates, static boiler plates or predefined paragraphs, preferences for certain expressions in contrast to others, etc). For example, a user may want to replace the use of “and/or” expressions by a formulation to avoid the use of parenthesis ( . . . “a variant selected from the group . . . ”).

To some extent, transformers (or other generation systems) can adapt to certain drafting “styles”, for example they can be trained to “learn” the style of patent documents filed by certain named assignees. As dictation software propose adaptation to users'own contents, generation methods and systems can be customized or adapted to approach the structure and/or lexicons of particular patents or families.

### Platform for Drafting

Different “rules” can be pursued to create different types of paragraphs (and further stacking them in a patent description).

In an embodiment, generation methods and systems can be unified into using a same “platform”, e.g., welcoming generation requests (examples provided by users, etc) so that more and more “know-hows can be captured. Instead of having to choose one platform than another, users may find centralized and “opened” rules to encode paragraphs. In this view, rules can be shared (“public”) or be kept “private” (for their own use).

### Earliest Occurrence

A simple but yet efficient measure is to detect the first use of a given term in an IPC class (in description, then in claims). For example, when did the term “touch” first enter the CPC class A65M (medical device) ? The technique has been used in smartphones since 2007, but it entered the medical field in 2011. The same types of analysis can be performed for many meaningful words (e.g. “holographic”, “blockchain”, “ledger”, “haptic”, “augmented reality”, etc).

### Context-Dependent Suggestions

In some embodiments, words'suggestions can be dependent on the context, for example by CPC (used as a filter to improve relevancy of suggestions).

Suggestions also can be determined and displayed in real-time, as drafting progresses.

### Snapshots Versioning of Claims

The drafting process in itself is highly creative. Before finalizing a claim tree, a drafter may consider dozens of variants or drafts. These intermediate steps generally disappear in that no traces or logs are generally kept from these drafts.

In an embodiment, intermediate states of claims or texts being drafted are recorded (e.g., at fixed time intervals, or depending on the text as typed, etc).

In an embodiment, the user or drafter can save snapshots of those intermediate and temporary states: said texts can be appended in the description, providing fallbacks if later useful during prosecution.

### Verticals Mining

Recurrent paragraphs in some IPC classes can be determined, isolated and further reinjected in drafts.

Data mining of the patent corpus can be performed so as to determine “vertical boiler plates” (e.g., extraction from corpus by CPC of recurrent paragraphs, for example in avionics, IoT, cryptography, etc). Depending on verticals (technical domains), patent applicants indeed have often the habit of reusing certain contents.

After collecting and aggregating these contents, a selection of such paragraphs can be proposed to the drafter: the corresponding libraries can be rendered available for users, who then can choose to import them (or not, or further modify them).

### Heatmaps

At stakes of the patent examination is the determination of so-called “essential features”. While machines can help identifying those words or groups of words (transformers can convert a text into a claim tree), it is advantageous to use human inputs.

In an embodiment, the user can “heat” and/or “freeze” certain parts of the sentence (e.g., claim). To “heat” means to indicate or markup or otherwise designate parts which have to be varied or otherwise modified. In some embodiments, intensity degrees can be specified (e.g., discrete levels). To “freeze” can mean that corresponding parts will not change. This can prove advantageous, as patent claim often comprise introductory parts of sentences, e.g., text chunks due to Case Law (for example “ . . . which cause a processor to perform the steps of . . . ” or “ . . . which comprise instructions which when executed on a processor cause said processor to perform the steps of”. In other words, the patent jargon or legalese can be removed, to clarify and further facilitate downstream text generation.

By heating and/or freezing parts of the sentence, one can indicate to the computer programs preferred zones or parts or areas wherein the text generation advantageously can be directed, increased or otherwise modified.

### User Interfaces

In an embodiment, there is provided a “expand” (or “reduce”) button-or the like such as a UI interface, e.g., gesture, zoom, pinch, etc-which can designate a part of the claim. If triggered, the sentence is increased in length (i.e., insertion of definitions, adding clauses, etc), respectively condensed (by deleting parts determined as unnecessary). This way, the drafter can manipulate parts of the text.

In an embodiment, the environment of the claim drafting dashboard is represented in 3D. For example, virtual reality can be used, so as to visualize and/or manipulate bag(s) of words. Augmented reality also can be used (e.g., showing mechanical parts, etc).

In an embodiment, words'suggestions are ruled with psychology and/or physiology factors: for example, depending on stress factors (respiration, perspiration) or favorable user's reactions (e.g., smiling, reactivity, etc), certain words or lexical directions can be favored while others can be kept un-displayed.

In an embodiment, text generation can be annotated, using crowdsourcing techniques.

### Publication and Early or Anticipated Publications

In an embodiment, text generated according to embodiments of presently described methods and systems can be published (e.g., in part, in full, “forever” or for a limited time, if not in an ephemeral manner).

In an embodiment, publication can be performed as Internet disclosure(s). In an embodiment, the publication is performed through the “patent channel”, filed with early publication before (official) Patent Offices. The advantage of using the official patent channels is that the corresponding texts will be natively indexed and then searched by patent offices (this is not guaranteed for Internet disclosures which can be ignored, at least at first). There are ways to publish at a very low cost in some jurisdictions (emerging countries yet member of patent treaties) and/or using particular legal provisions (e.g., official “early publication” can be requested without having to pay expensive examination fees for example).

### «Artificial» or «Synthetic» Patents Versus «Natural« Patents

In an embodiment, entire assets, descriptions (or US specifications), can be generated based on provided existing claims (computer-generated or handcrafted ones).

Artificial patents and natural words can be compared, paragraph by paragraph, if not lines by lines. Associated legal effects can be determined. Discrepancies between natural patents and artificial patents can be determined and used to improve generations. Some synthetic texts can be found not be not made by man (spontaneously), while some human texts may not be found to be generated by machines. In all cases, a text comprises words put in a certain order and this is no reasons to identify texts which cannot be algorithmically generated. In this situation, synthetic patents may go beyond human average (notion of “augmented patents”).

Generated corpus is corpus A. Initial claims are associated with handwritten specifications forming a corpus B. These datasets can be compared, so as to improve the generation (reducing the differences, or mitigating them). In an embodiment, machine learning is performed on individual pairs, not masses of corpus. In an embodiment, masses of patents are compared. In an embodiment, comparisons are performed by machine learning which is supervised. For example, advantageously, the different sections of the patent specifications (i.e., technical domain, background, summary, detailed description comprising definitions first, enriched recopy of claims, etc) are recognized, at least identified or marked, so as to align texts and improve comparisons. In an embodiment, comparisons performed by machine learning is unsupervised (e.g., by deep learning).

In an embodiment, a part of the specification is at least partially generated from a claim tree. Via questions and answers by the user (e.g., technical effect associated with a combination of claims'features), another part of the specification can be generated. Another part can be generated using machine learning (for example GPT-3)

### Smart Changes

In patent documents, good and bad practices can be individualized, i.e., there can be considered preferred expressions by contrast to others.

For example, the expression “A controls B” can be advantageously changed into “A can control B”. A button or option “replace is by can” can allow to treat an entire document (special find and replace feature).

Other shortcuts or functions or quality metrics can be for example “check absence of the term invention” or “no-cross references” in a document. More diverse functions can be envisioned for example “add mentions of examples”, “check for possible patent profanity” (avoid presence of words with excessive limitations such as “always”, “essential”, “critical”, etc.)

### Management of Portfolios (“Sedimentation”)

Aside from avoiding self-collisions, many applicants can have poor management of subsequent patent filings. Outside counsels also often overlook such aspects (e.g., change in drafters which can lead to ignorance of previous drafts). In particular, applicants in the industry often have patenting cycles mirroring product developments. These cycles may or may not appear compatible with patent matters'timings.

It is thus advantageous to propose an efficient way to reuse “assets”, in combination with current filings. The relevant reuse in combination of past assets can be called “sedimentation”.

In an embodiment, former claims 1 or abstracts (recopying claim 1 and providing key elements of the claim tree) are backed-up, retrieved and reinjected in subsequent patent filings, of related interests. The recopy can be slightly adjusted to combine former features with features envisioned for patent filings. With respect to time windows, the 12-month and 18-month periods shall be considered. It is possible to archive a dense or “sedimentation” text providing the gist of claims, and to associate a filing date to said texts. Later on, when filing a related patent, published fallbacks can be combined with new claims.

Beyond static elements, each associated with a patent filing, aggregation can occur per theme or topic or subject-matter. The drafting of such texts can be further modified in order to increase the density of the semantics (compromise or trade-offs between the size or length of the dynamic boiler plates) and cover multiple inventions at once.

For example, suppose that a company in the field of avionics files patent applications related to Human Machine Interfaces (IHM). The first (published) application discloses a screenless display system (e.g., holographic display). Now, a second application discloses a haptic feedback system, which counteracts turbulence felt in the cockpit. It can be advantageous to file a dependent claim which is directed towards the coupling of such screenless display with the haptic system in sight. Even if relevant, such synergies are not necessarily described and claimed, in a non-optimized environment. Later on, a third application changes the focus of patenting and the subject-matter of the two first applications are forgotten or overlooked. When a fourth application filing occurs, related to IHM, quite often organizations can forget to establish the link with previous filings. A good practice is to remind the drafter of the previous drafts and to propose concatenation or other compacting of previous drafts.

In a first version, the entire claim tree can be remembered and restituted. Later on, after the second draft, another version combining the two filings can be determined. A third version can further compact the three developments (e.g., in a few sentences) and be later combined with the fourth filing.

In other words, the payload of past filings can be progressively aggregated and reused, advantageously for patent matters if time periods are appropriately managed.

In practice, texts can be dated (filing date, publication date) and versioning can be managed in order to “pack” or “gather” or “sediment” previous filings.

1. A method for generating text comprising:
receiving text input;
determining generated text by using a transformer-based generation as an input and/or as an output of one or more rules applied on said transformer-based generation.

2. The method of claim 1, wherein a rule comprises one or more logical rules associated with one or more logics selected from the group comprising Boolean logic, binary logic, fuzzy logic, probabilistic logic, intuitionistic logic, combinatorial logic, modal logic, propositional logic, polyvalent or multivalent logic, partial logic, or para-consistent logic.

3. The method of claim 1, wherein a generated text triggers the application of one or more rules, said rules further modifying the generated text.

4. The method of claim 1, wherein a rule triggers a transformer-based generation of text.

5. The method of claim 1, wherein a transformer is a finite-memory transformer.

6. The method of claim 1, wherein a transformer is an infinite-memory transformer.

7. The method of claim 3, wherein a rule completes the text generated by transformer-based generation, or parts thereof.

8. The method of claim 3, wherein a rule deletes the text generated by transformer-based generation, or parts thereof.

9. The method of claim 1, further comprising:
determining one or more selectable generated texts as a response to said text input;
displaying said selectable generated texts;
receiving a selection of a text amongst selectable generated texts;
replacing said input text by said selected text and/or appending said selected text to the text input thereby forming a completed text.

10. The method of claim 1, further comprising:
predicting text based on transformer-based language models;
determining text based on one or more prior art documents, wherein the combination of determined words of said predicted text is not present in a predefined corpus representative of prior art.

11. The method of claim 1, further comprising using an adversarial generation network for generating and/or modifying generated text.

12. The method of claim 1, wherein a part of the text is further simplified, wherein simplification uses one or more plain English dictionaries, to replace one or more words of the initial text.

13. The method of claim 1, wherein a part of the text is further generalized, wherein the generalization uses a combination of hyponyms, hyperonyms, synonyms and meronyms.

14. The method of claim 1, further associating a generated patent with one or more non fungible tokens.

15. The method of claim 14, wherein each patent claim is associated with an advantage and/or a technical effect.

16. The method of claim 15, wherein advantages and technical effects are predefined and a probability of association is computed based on features of the independent or dependent claim.

17. The method of claim 1, wherein a predefined static template is selected from a plurality of predefined templates, wherein a template comprises predefined uncomplete sentences, e.g., with missing words i.e., nouns and/or verbs.

18. The method of claim 1, further handling a dynamic template, wherein said dynamic template is determined from one or more predefined templates and further modified based on the textual context defined by words having being typed or entered by the user or a group of users.

19. The method of claim 1, wherein one or more rules govern the generation of one or more words of the generated text.

20. The method of claim 19 wherein one or more parameters and/or constraints are set up or modified for the generation, e.g., hyper parameters of the transformer-based generation and/or data associated with one or more GANs.

21. The method of claim 1, further comprising a graphical user interface exposing selectable icons to apply one or more text transformations amongst: generalize, specify, paraphrase, rewrite.

22. The method of claim 21, wherein the paraphrasing is determined according to one or more selectable thresholds or levels, for example low or medium or high levels of changes brought to the selected part of the text or generated text.
